(19) United States
(12) Patent Application Publication
(10) Pub. No.: US 2022/0219335 A1
(43) Pub. Date: Jul. 14, 2022

(54) GRIPPING APPARATUS

(71) Applicant: Festo SE & Co. KG, Esslingen (DE)

(72) Inventor: Markus Aegerter, Altbach (DE)

(21) Appl. No.: 17/615,322

(22) PCT Filed: May 18, 2020
(86) PCT No.: PCT/EP2020/063800

§ 371 Date: Nov. 30, 2021

(30) Foreign Application Priority Data
Jul. 3, 2019 (DE) 10 2019 209 755.3

(51) Int. Cl. B25J 15/00; B25J 15/10

(52) U.S. Cl. CPC B25J 15/0028; B25J 15/10

(57) ABSTRACT

A gripping apparatus which has a base body (5) and a plurality of gripping arms (18) arranged on the base body (5) so as to be distributed about a center axis (4). The gripping arms (18) can be driven to carry out a gripping arm pivoting movement (22) in order to grip or release an object. All of the gripping arms (18) are integrated into a gripping unit (11) which is separate from the base body (5) and which has a fastening sleeve (15) to which the gripping arms (18) are fastened and which is axially placed on the base body (5) by means of a sleeve-shaped fastening portion (62), assuming a usage position. The gripping unit (11) is detachably fixed in the usage position by means of a securing device (78).

The invention relates to a gripping apparatus comprising a base body and several gripping arms which are arranged on the base body in a manner distributed about a center axis, wherein each gripping arm is pivotable relative to the base body about a pivoting range whilst carrying out a gripping arm pivoting movement and wherein all gripping arms by way of an actuation device of the gripping apparatus can be driven synchronously in a selective manner into an inwards pivoting movement which is orientated inwards in the direction of the center axis or into an outwards pivoting movement which is oriented outwards away from the center axis.

A gripping apparatus of this type which is known from DE 30 11 837 A1 has two opposite gripping arms which are individually fastened by way of screws to two side surfaces of a mounting part which is designed as a metal block, said side surfaces being opposite one another. Each gripping arm comprises a leaf spring which is creased several times in the longitudinal direction and is pivotable by way of a mechanical actuation device. The mechanical actuation device has a pneumatic cylinder which is fastened to the mounting part and on whose piston rod several pressing elements are fastened, said pressing elements being able to roll on the outer surface of the leaf springs given a linear movement of the piston rod. An inwards pivoting movement of the gripping arms which is directed towards one another results from the mechanical impingement on the part of the pressing elements which are moved in a first axial direction by the pneumatic cylinder. An opposite outwards movement of the gripping arms results from the intrinsic spring force of the leaf springs when the pressing elements are moved back in a second direction which is opposite to the first direction. An exchange of the gripping arms is rendered possible by way of the respectively assigned screw connection being released. The handling entailed by this is relative cumbersome.

A gripping apparatus which has several gripping arms which are rigid per se and which are pivotably mounted on a base body independently of one another in a pivoting region which is formed by a joint is known from DE 10 2004 059 342 A1. The gripping arms can be driven synchronously into an inwardly or outwardly directed pivoting movement by way of a permanent-magnetic actuation device. The permanent-magnetic actuation device has an outer permanent magnetic arrangement with outer permanent magnets which are arranged on the gripping arms and further comprises an inner permanent magnet arrangement which is arranged on the base body in an axially movable manner and which is composed of several inner permanent magnets. Depending on the position of the inner permanent magnet arrangement, the inner and outer permanent magnet units mutually repel or attract, so that the gripping arms either carry out an outwards pivoting movement or an inwards pivoting movement. For its pivotable mounting, each gripping arm is seated on a bearing journal which is fixed on the base body, in a pivotably movable manner.

It is the object of the present invention to provide a gripping apparatus which given a simple and inexpensive construction permits a user-friendly application.

For achieving this object, in combination with the initially mentioned features, according to the invention one envisages the gripping arms being integrated into a gripping unit, said gripping unit being separate with respect to the base body, comprising a fastening sleeve which carries all gripping arms, being stuck with a sleeve-like fastening section of the fastening sleeve onto the base body in the axis direction of the center axis and in a position of use which is assumed by way of this being releasably fixed on the base body by way of a securing device.

In this manner, all gripping arms of the gripping apparatus are grouped together into a construction unit which can be handled as a unit, is denoted as a gripping unit, is designed separately with regard to the base body of the gripping apparatus and can be fixed or is fixed on the base body in a very simple manner by way of a stick-on procedure, in order to equip the gripping apparatus with gripping arms which are desired for a gripping procedure. The fixation of the gripping unit on the base body is effected by way of a fastening sleeve of the gripping unit, on which fastening sleeve all gripping arms are attached in a pivotable manner. The fastening sleeve has a sleeve-like fastening section with which the gripping unit can be stuck onto the base body in the axis direction of the center axis, in order to bring the gripping unit into its position of use on the base body. The stuck-on gripping unit is fixed to the base body in a releasable manner by way of a securing device, so that it can be removed from the base body again at all times, in order for example to carry out a rapid refitting with respect to a different gripping task by way of exchange. There is the advantageous possibility of providing several gripping units with fastening sleeves which are identical amongst one another, but with gripping arms which are designed differently from one another and which from case to case can be stuck on the base body into the position of use depending on the gripping requirements. The releasable fixation of the gripping unit also provides for a rapid exchange in the case of damage, so that the standstill times given the use of the gripping apparatus can be reduced to a minimum. In this context, it is advantageous if the assembly and disassembly of the gripping unit is possible in a purely manual and in particular also tool-free manner.

Advantageous further developments of the invention are defined in the dependent claims.

It is considered as being particularly expedient if the fastening sleeve and the base body are designed in a manner matched to one another such that the fastening sleeve for assuming its position of use can be stuck onto the base body in the axis direction of the center axis by way of a purely linear stick-on movement. A disassembly in this case can preferably be carried out by an oppositely orientated purely linear pull-away movement of the gripping unit. Compared to a basically likewise possible design, concerning which the stick-on movement is a combined insert-rotation movement, comparable to a bayonet connection, the purely linear assembly direction and disassembly direction can be realised in a particularly inexpensive manner.

The securing device which is responsible for the securing of the stuck-on position of use is preferably designed such that it is effective between the base body and the sleeve-like fastening section of the fastening sleeve. The gripping arms hereby make no contribution to the securing of the position of use.

The securing device is preferably formed by way of at least one locking device. A single locking device is preferred, but nevertheless several locking device can be arranged distributed about the center axis. The locking device preferably has a first locking structure which is arranged on the base body and a second locking structure which is arranged on the sleeve-like fastening section of the fastening sleeve, wherein the two locking structures are designed complementarily to one another, so that they can come into releasable locking engagement with one another. One of the two locking structures is designed in an immovable manner, whereas the other locking structure is movable, in order when necessary to be able to carry out a locking procedure or unlocking procedure with respect to the immovable locking structure.

Preferably, the first locking structure which is arranged on the base body is designed in an immovable manner, whereas the second locking structure which is arranged on the sleeve-like fastening section of the fastening sleeve is a movable locking structure. The movable second locking structure which belongs to the fastening sleeve is comfortably accessible from the outside for its manual handling.

An embodiment of the locking device as a snap-connection device is seen as being particularly expedient. In this manner, the two locking structures can be come into latching engagement with one another in an automatic manner when the gripping unit is stuck onto the base body in the position of use. The movable locking structure can be deflected in a spring-elastic manner for unlocking. For example, the movable locking structure can be resiliently fixed to the sleeve-like fastening section such that it normally assumes a locking position and can be deflected and in particular pivoted, by hand, possibly whilst using a manually actuatable lever tool, into an unlocking position whilst overcoming a resilient restoring force.

The gripping apparatus is expediently provided with at least one linear guide device which is effective between the base body and the sleeve-like fastening section of the fastening sleeve and by way of which the fastening sleeve is guided in a linearly displaceable manner relative to the base body on axially sticking onto the base body as well as on axially withdrawing from the base body. The linear guide device effects a transverse supporting in the circumferential direction of the center axis, so that a very exact assembly and disassembly of the gripping unit is possible and at all times it is ensured that the gripping unit—even in the position of use—is supported in a non-rotatable manner about the center axis with respect to the base body. Herewith, on using the gripping apparatus, it is ensured that even given high transverse forces or torsion forces, a relative rotation between the gripping unit and the base body is avoided.

During its use, the gripping apparatus is expediently fixed to a robot or to another handling device via the base body. For this purpose, the base body is provided with at least one mechanical fastening interface.

The linear guide device expediently has a guide groove, said guide groove being formed in an outer peripheral surface of the base body which faces radially outwards with respect to the center axis and extending in the axis direction of the center axis, and furthermore comprises a guide rib which engages into the guide groove in a slidingly displaceable manner and which is formed on a radial inner peripheral surface of the sleeve-like fastening section of the fastening sleeve. This arrangement can also be exchanged, so that the guide rib is formed on the outer periphery of the base body and the guide groove on the inner periphery of the sleeve-like fastening section.

If the gripping apparatus is provided with a locking device as well as a linear guide device, it is then advantageous if the first locking structure is arranged in the longitudinal course of the guide groove of the linear guide device and the second locking structure in the longitudinal course of the guide rib of the linear guide device. In this manner, the functions of the locking and of the linear guidance can be combined in a small construction space.

The inner periphery surface of the sleeve-like fastening section and at least the section of the outer peripheral surface of the base body, said section being encompassed by the sleeve-like fastening section in the position of use are preferably designed complementarily to one another, so that the sleeve-like fastening section can be very well supported all around in the radial direction with respect to the base body. The mentioned surfaces are preferably designed in a circularly cylindrical manner.

It is advantageous for the user of the gripping apparatus if he has knowledge of the current operating state. For this, the gripping apparatus can be equipped with a light display device which visualises at least one operating state. This light display device is expediently accommodated in the inside of the base body in a well protected manner. In order for the light signals to be recognisable from the outside, at least one viewing window which permits the passage of light passes through the sleeve-like fastening section of the fastening sleeve. The viewing window can be open but can alternatively be closed in a manner which is transparent to light. Preferably, several viewing windows are formed in the sleeve-like fastening section around the center axis, so that the current operating state can be recognised from several viewing directions. The light display device, for example with different light colours, can signalise whether the gripping arms assume an open position or a closure position or whether an operational malfunction is present.

The light display device is expediently realised amid the use of one or more LEDs.

For the purpose of a high stability, the fastening sleeve at an axial front side expediently comprises a closed bottom section which is arranged axially in front of the base body when the gripping unit assumes its position of use.

Each gripping arm expediently has a rear end section, to which it is fixed to the sleeve-like fastening section of the fastening sleeve in a pivotably movable manner whilst defining the assigned pivoting region. Departing from this rear end section, each gripping arm extends axially to the front, wherein with a front end section it projects to the front beyond the fastening sleeve. The front end section of the fastening sleeve functions as a gripping section which can be applied onto an object, in order to grip it for a subsequent transport. The gripping section can be integrated into the gripping arm as one piece, but can however also be arranged in a releasable manner, so that it can be easily exchanged when required.

Concerning an embodiment which is seen as being particularly favourable, the gripping elements are designed such that they are connected at their rear end section to the sleeve-like fastening section as one piece and in a bending-flexible manner amid the formation of a solid-body joint. Compared to an embodiment of the pivoting region which is designed as a joint with parts which are movable relative to one another, which in principle is also possible, the realisation as an integral solid body joint has the advantage that no friction occurs given the gripping arm pivoting movement, which minimises the wear and avoids wearing. The latter predestines the gripping apparatus for applications within restricted spaces and/or in the laboratory field.

Each gripping arm is expediently designed in a lamella-like manner and/or in the manner of a leaf spring, at least in the region of the bending-flexible solid body joint. The solid body joint can have a very high elasticity, so that the pivotable gripping arm can be deflected transversely to its longitudinal direction with very little force.

The fastening sleeve expediently has a sleeve-like front sleeve end section, through whose wall several longitudinal slot pass, said slots being distributed around the center axis, extending in the longitudinal direction of the fastening sleeve and in which one of the gripping arms extends. The number and angular distribution of the longitudinal slots with respect to the center axis therefore corresponds to that of the gripping arms. The front sleeve end section contributes to the stability of the fastening sleeve, wherein the longitudinal slots ensure that the gripping arms can be pivoted very far radially inwards given their inwards pivoting movement. By way of this, a very large pivoting range is realised, which permits the gripping of small as well as larger objects.

The already mentioned optional bottom section of the fastening sleeve is expediently attached to the front sleeve end section at the front, wherein in particular it is designed as one piece with this front sleeve end section.

The complete fastening sleeve is expediently designed as one piece. It is advantageous of the gripping arms are attached to the sleeve-like fastening section as one piece, so that the complete gripping unit can be designed as one piece. The gripping unit preferably consists as a whole of a plastic material.

The fastening device of the gripping apparatus can basically be based on an arbitrary functioning principle. For example, the actuation device can be designed in order to create the gripping arm pivoting movement by way of mechanical action. Hereby, the actuation device can for example comprise an actuation unit which is movable by way of a drive unit and which is mechanically coupled to the present gripping arms in a force-transmitting manner.

However, an embodiment of the actuation device as a permanent-magnetic actuation device is seen as being particularly advantageous. Such a permanent-magnetic actuation device in particular has an outer permanent magnet arrangement which is arranged on the gripping arms, as well as an inner permanent magnet arrangement which is a constituent of an actuation unit which is movable relative to the base body and to the gripping arms. The outer permanent magnet arrangement comprises a plurality of outer permanent magnet units, wherein each gripping arm is equipped with such an outer permanent magnet unit. The actuation unit can be positioned in different working positions whilst carrying out a working movement, in order to either magnetically attract or magnetically repel the outer permanent magnet units for creating the gripping arm pivoting movement.

An embodiment concerning which the working movement of the actuation unit is a rotational working movement about a rotation axis which is equally directed to the center axis is seen as being particularly advantageous, wherein the inner permanent magnet arrangement comprises a plurality of inner permanent magnet units which are arranged distributed about the rotation axis and whose relative position which is assumed with respect to the outer permanent magnet units is changeable by way of the rotational working movement amid the change of the magnet forces which act between the inner permanent magnets and the outer permanent magnets.

Irrespective of this, a permanent-magnetic actuation device can also be realised to the extent that the working movement of the actuation unit which comprises the inner permanent magnet arrangement is a linear movement in the axis direction of the center axis.

For generating the working movement of the actuation unit, the gripping apparatus is expediently equipped with a drive unit, said drive unit being operated electrically or by way of fluid force, being attached on or in the base body and with regard to drive is coupled to the actuation unit. The drive unit is preferably a rotation drive unit.

Expediently, an electric drive unit comprises an electric motor which is designed as a stepper motor or servomotor. For example, it can be a programmable electric servomotor with which the actuation unit can be positioned in different working positions in a variable manner.

The base body expediently comprises a housing which defines a housing chamber in which the actuation unit and expediently also the preferably present drive unit are received. The housing chamber at least in the context of a permanent-magnetic actuation device is expediently peripherally delimited by a non-magnetisable housing side wall, in order to permit an uninhibited passage of the magnetic field lines.

It is advantageous if the gripping apparatus is provided with a sensor device which is designed for detecting at least one operating state of the gripping apparatus. The sensor device in particular is capable of detecting at least one and preferably each pivoting position of at least one and preferably of each gripping arm, said pivoting position being adjustable by way of the gripping arm pivoting movement. In this manner a very simple position monitoring of the gripping arms is possible.

The sensor device can be realised in a particularly inexpensive manner in the context of a permanent-magnetic actuation device by way of the inner permanent magnet arrangement and/or the outer permanent magnet arrangement being used in order to activate the sensor device. In this case, the sensor device expediently comprises one or more Hall sensors.

The detected operating state can expediently be led to an electronic control device which can be designed as a constituent of the gripping apparatus. Preferably, the determined operating states can be visualised by way of the at least one light display device which is mentioned further above.

The gripping unit can be realised with an arbitrary number of gripping arms. For example, it comprises three or four gripping arms which are distributed about the center axis, wherein this is expediently a uniform distribution. The gripping apparatus can comprise several gripping units which can be attached to the base body in the position of use alternatively to one another and which can differ from one another in the number of their gripping arms.

The invention is hereinafter explained in more detail by way of the attached drawing. In these are shown in:

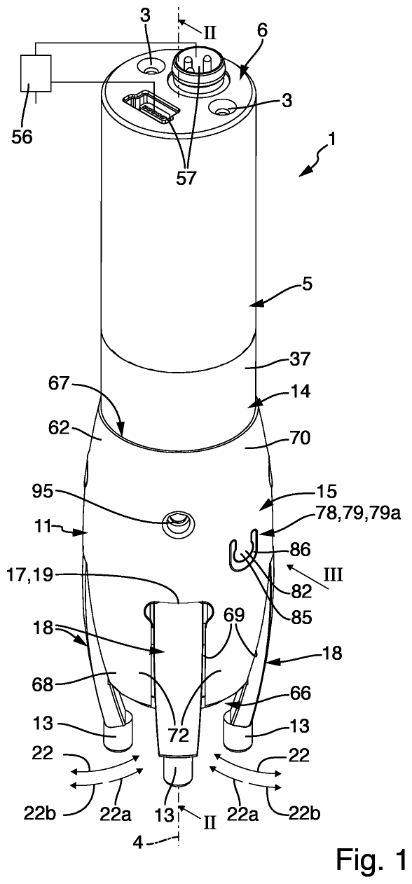

FIG. 1 a preferred construction form of the gripping apparatus according to the invention in a perspective representation, wherein the gripping arms are shown on assuming an inwardly pivoted inner pivoting position which is also denoted as a closure position,

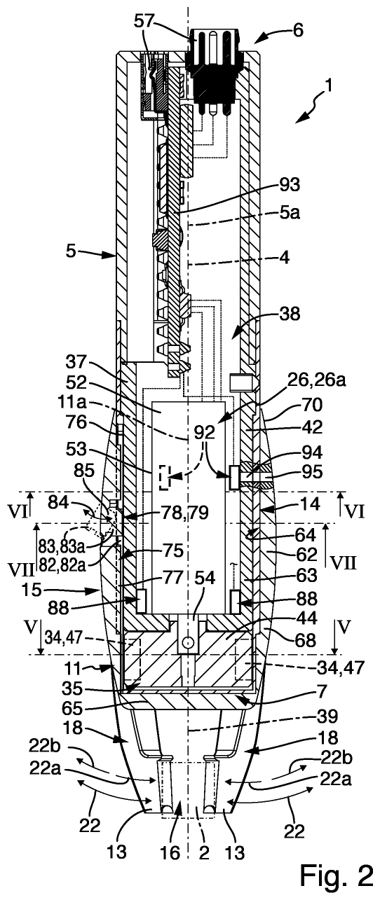

FIG. 2 a longitudinal section of the gripping apparatus according to the section line II-II of FIG. 1,

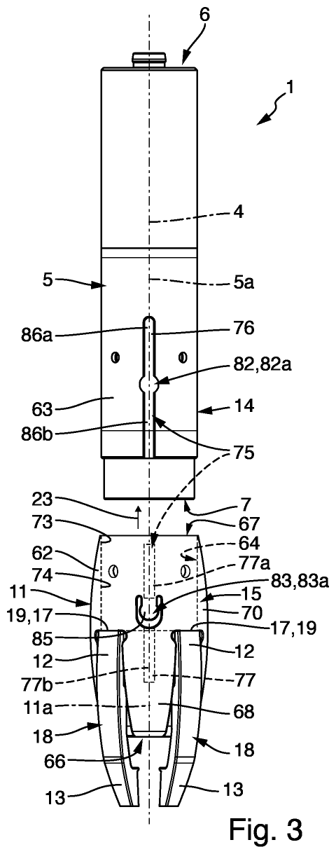

FIG. 3 a lateral view of the gripping apparatus with a viewing direction according to arrow III of FIG. 1 in a standby position of the gripping unit in which it is not yet stuck onto the base body,

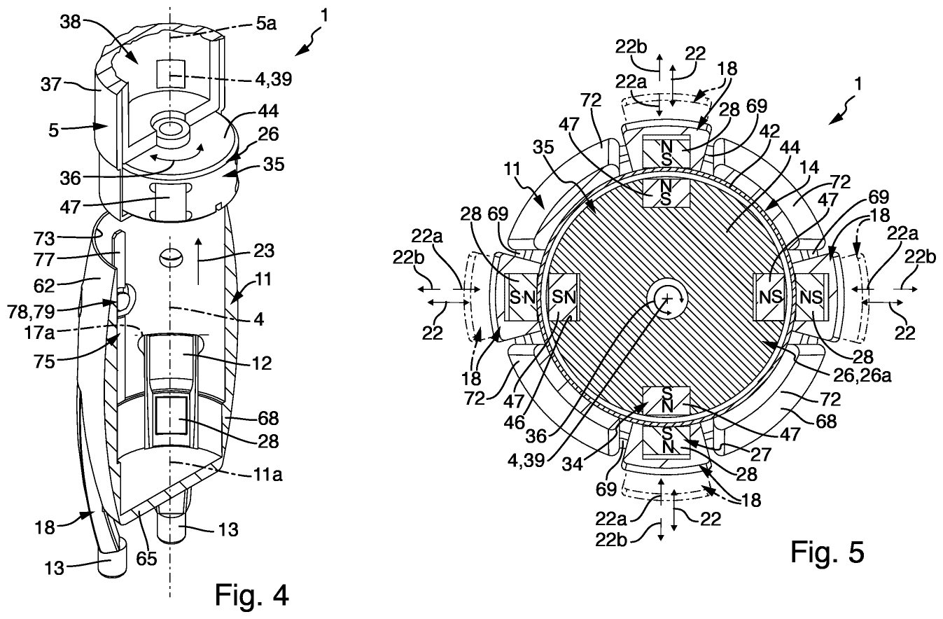

FIG. 4 an isometric longitudinal section of the end section of the gripping apparatus which lies at the bottom in FIG. 3, wherein a drive unit which is accommodated in the base body is not illustrated,

FIG. 5 a cross section of the gripping apparatus according to the section line IV-IV of FIG. 2, wherein the gripping arms are shown on assuming the inner pivoting position or closure position and wherein the gripping arms are furthermore shown in a dot-dashed manner also on assuming an outer pivoting position which is denoted as the open position,

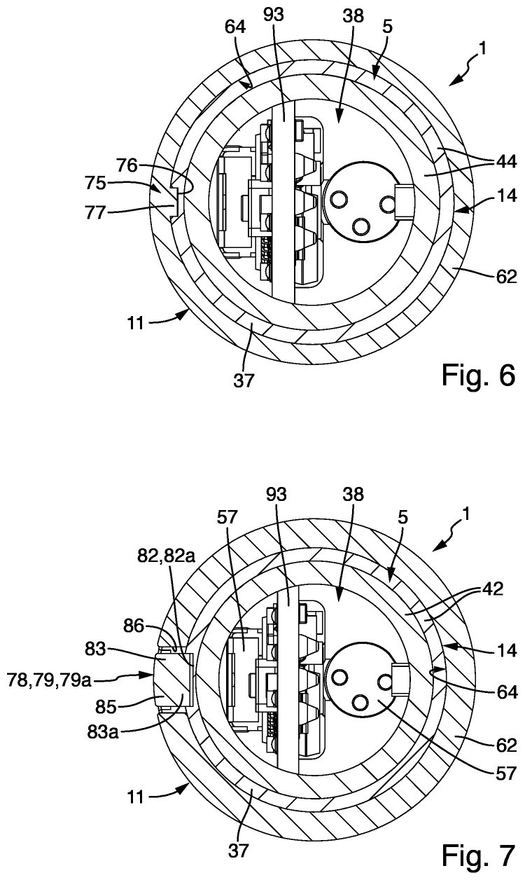

FIG. 6 a cross section of the gripping apparatus according to section line VI-VI of FIG. 2,

FIG. 7 a cross section of the gripping apparatus according to section line VII-VII of FIG. 2,

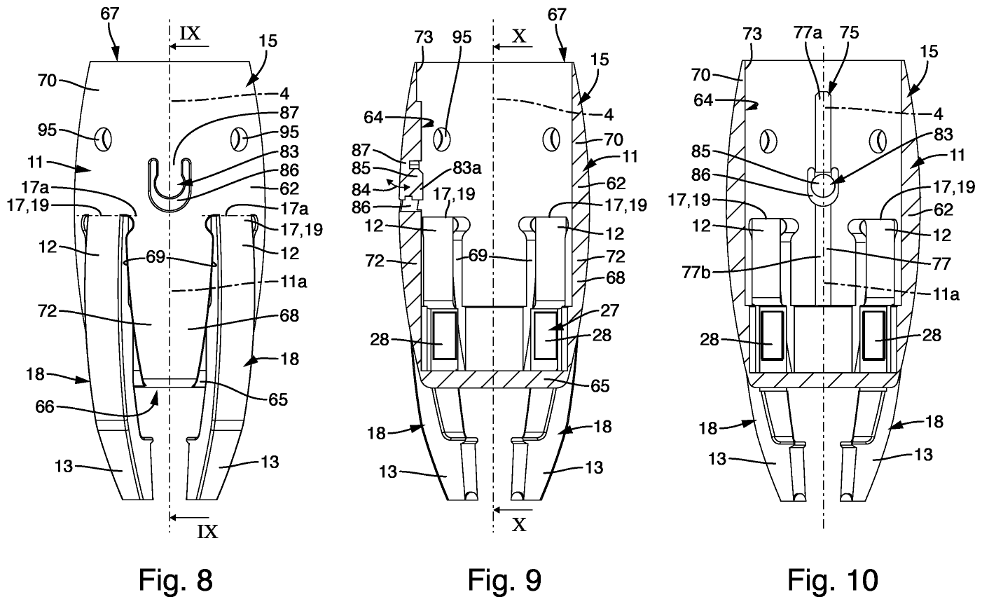

FIG. 8 an individual representation of the gripping unit in a lateral view with a viewing direction according to arrow III of FIG. 1,

FIG. 9 a cross section of the gripping unit according to section line IX-IX of FIG. 8, and

FIG. 10 a cross section of the gripping unit according to section line X-X of FIG. 9.

The gripping apparatus 1 which is illustrated in the drawing permits the releasable gripping of individual objects 2, of which one is indicated in FIG. 2 in a dot-dashed manner.

The gripping apparatus 1 has a mechanical fastening interface 3, with which it can be fixed to the movable arm of a robot which is not illustrated further or of another handling device. By way of this, the gripping apparatus 1 can be moved in space, in order to grip an object 2, to displace it to another location or to let go of it again.

With regard to the objects 2, these can be technical objects such as workpieces, but can also be foodstuffs or medical articles. This listing however is not to be understood as conclusive.

The gripping apparatus 1 has an imaginary central longitudinal axis which is denoted as a center axis 4. It has a base body 5 which has a longitudinal extension, extends in the axis direction of the center axis 4 and by way of example has a longitudinal axis 5a which coincides with the center axis. The fastening interface 3 is preferably formed on the base body 5 and by way of example consists of two fastening holes.

The base body 5 has a rear side 6 which in the illustrated alignment faces upwards and a front side 7 which by way of example faces downwards and which is axially opposite with respect to this.

The gripping apparatus 1 comprises several gripping arms 18 which are arranged around the center axis 4 in a certain distribution. It is preferably a uniform distribution.

With regard to the preferred embodiment example, the gripping apparatus 1 is equipped with in total four gripping arms 18 which—as can be seen particularly well in FIG. 5—are distributed uniformly around the center axis 4 in angular intervals of 90°. With regard to non-illustrated alternative embodiment examples, the gripping apparatus 1 only has two or three such gripping arms 18.

The gripping arms 18 have an elongate, for example finger-like shape. They can be designed in a straight-lined manner in their longitudinal direction or can be bent away once or several times.

Each gripping arm 18 has a rear end section 12, via which it is fixed to the base body 5. The fixation is effected in a manner which has yet to be described, amid the intermediary of a gripping unit, into which the gripping arms 18 are integrated and which for its part is releasably fastened to the base body 5.

The rear end sections 12 of the gripping arms 18 lie between the rear side 6 and the front side 7 in the region of an outer peripheral surface 14 of the base body 5 which faces radially outwards. Departing from there, each gripping arm 18 extends in the direction to the front side 7, wherein it ends freely with a front end section 13 which projects axially to the front beyond the front side 7 of the base body 5. The front end section 13 is hereinafter also denoted as a gripping section 13 on account of its function. The function of the gripping sections 13 lies in laterally impinging an object 2 to be handled and gripping and fixedly holding it on account of this. The gripping sections 13 of all gripping arms 18 surround a gripping space 16 which is arranged in front of the base body 5 at the front side 7 and in which the object to be gripped 2 is at least partially placed.

The gripping sections 13 could be designed differently depending on the shaping of the object 2 which is to be gripped. Two different design possibilities are illustrated in the drawing. FIGS. 1 and 4 show a design with circularly cylindrical gripping sections 13, whereas the gripping sections 13 of the other embodiment examples are designed in a jaw-like manner with plane or concavely arcuate gripping surfaces.

All gripping arms 18 as already mentioned are integrated into the gripping unit 11 which is separate with regard to the base body 5. The gripping unit 11 has a longitudinal axis 11a and during designated use of the gripping apparatus 1 is releasably fastened to the base body 5 amid the assumption of a position of use which is evident from the FIGS. 1, 2 and 4 to 7.

The fastening of the gripping unit 11 to the base body 5 is effected amid the intermediary of a fastening sleeve 15 of the gripping unit 11. The fastening sleeve 15 functions as a fastening interface between the gripping arms 18 and the base body 5. All gripping arms 18 are fastened to the fastening sleeve 15, so that together with the fastening sleeve 15 they form a construction unit which can be handled as a unit, specifically the mentioned gripping unit 11.

Preferably, each gripping arm 18 is fixed at its rear end section 12 to the fastening sleeve 15 in a pivotably movable manner. The region of the pivotably movable fixation is hereinafter denoted as a pivoting region 17 and defines an imaginary pivoting axis 17a, about which the assigned gripping arm 18 is pivotable to and fro whilst carrying out a gripping arm pivoting movement 22 which is indicated by a double arrow. All pivoting axes 17a lie in a common pivoting bearing plane which is at right angles to the center axis 4.

The gripping arm pivoting movement 22 can alternatively be an inwards pivoting movement 22a which is orientated in the direction of the center axis 4 or an outwards pivoting movement 22b which is opposite with respect to this and is away from the center axis 4. Given the inwards pivoting movement 22a, the gripping sections 12 radially approach the center axis 4, whereas they distance themselves from this center axis 4 given an outwards pivoting movement 22b. The gripping arm pivoting movement 22 always takes place simultaneously and in the same direction with all gripping arms 18.

In the drawing, all gripping arms 18 are shown on assuming an inner pivoting position which is also denoted as a closure position and in which the gripping arms 18 with their gripping sections 13 are approached as far as possible to the center axis 4. An outer pivoting position of the gripping arms 18 which is also denoted as an open position and in which the gripping arms 18 are arranged at the largest possible distance to the center axis 4 is illustrated in a dot-dashed manner in FIG. 5.

For the assembly of the gripping apparatus 1, the gripping unit 11 can be stuck on in the course of a stick-on movement 23, indicted by an arrow, from a standby position which is assumed by the base body 5 and is evident in FIGS. 3 and 4, into a position of use which is seated on the base body 5 and which is evident from the FIGS. 1, 2, 6 and 7. The sticking-on is effected with a coaxial alignment between the gripping unit 11 and the base body 5 and is effected from the front side 7 of the base body 5. The gripping unit 11 is stuck onto the base body 5 with its fastening sleeve 15.

Specifically, the fastening sleeve 15 comprises a sleeve-like fastening section 62 with which it is coaxially stuck onto a front end section 63 of the base body 5 which connects onto the front side 7. The sleeve-like fastening section 62 has a radial inner peripheral surface 64 which is preferably designed in a circularly cylindrical manner and complementarily to the radial outer peripheral surface 14 of the base body 5 in the region of the front end section 63. The radial outer peripheral surface 14 in the region of the front end section 63 as well as the radial inner peripheral surface 64 of the sleeve-like fastening section 62 preferably have a circular cross-sectional contour, wherein these surfaces are matched to one another such that the sleeve-like fastening section 62 given its assembly can axially slide past the front end section 63 of the mains body 5 and is herein radially supported.

Concerning the preferred illustrated embodiment example, the sleeve-like fastening section 62 assumes the complete axial length of the fastening sleeve 15. Disregarding a preferably plate-like closed bottom section 65 which is located in the region of an axial front side 66 of the fastening sleeve 15 and is arranged in front of the base body 5 in the position of use of the gripping unit 11, the complete fastening sleeve 15 extends axially along the outer peripheral surface 14 of the base body 5. The bottom section 15 effects a stiffening of the fastening sleeve 15.

The gripping arms 18 are fixed with their rear end section 12 to the sleeve-like fastening section 62 in a pivotably movable manner. The fixation regions which each define one of the pivoting regions 17 are distanced to the axial front side 66 as well as to the axial rear side of the fastening sleeve 15 which is opposite with respect to this. In this manner, the pivoting regions 17 are placed at an axial distance to the front side 7 in the region of the outer periphery of the base body 5. All gripping arms 18 projects with their front end sections 13 axially beyond the front side 66 of the fastening sleeve 15, and hence also beyond the bottom section 65 which defines the front closure of the fastening sleeve 15.

The gripping arm pivoting movement 22 is a relative movement of the gripping arms with respect to the fastening sleeve 15 which is fastened to the base body 5 in the position of use.

The fastening sleeve 15 has a front sleeve end section 68 which connects axially onto a rear sleeve end section 70 of the fastening sleeve 15. This front sleeve end section 68 in the case of the illustrated embodiment example belongs to the sleeve-like fastening section 62. The front sleeve end section 68 is therefore also seated on the radial outer peripheral surface 14 of the base body 5 in the position of use of the gripping unit 11. The bottom section 65 at the end face to the front is arranged on the front sleeve end section 68,

The pivoting regions 17 by way of example are arranged on the rear sleeve end section 70, in particular in the transition region to the front sleeve section 68.

The front sleeve end section 68 is characterised in that several longitudinal slots 69 which are distributed about the longitudinal axis 11a and thus also about the center axis 4 pass radially through its wall. The longitudinal slots 69 extend in the axis direction of the longitudinal axis 11a of the gripping unit 11. The distribution and number of the longitudinal slots 69 corresponds to the distribution and number of the gripping arms 18. One of the gripping arms 18 extends in each longitudinal slot 69, wherein the width of each longitudinal slot 69 is matched to the width of the assigned gripping arm such that the gripping arm 18 is movable in the assigned longitudinal slot 69 given the gripping arm pivoting movement.

A web section 72 of the front sleeve end section 68 which connects the sleeve-like fastening section 62 to the bottom section 65 extends between the longitudinal slots 69 which are arranged successively in the circumferential direction of the longitudinal axis 11a. By way of this, the front sleeve end section 68 has a cage-like structure.

According to an embodiment example which is not illustrated, the front sleeve end section 68 cannot belong or can only partly belong to the sleeve-like fastening section 62, so that in the assembled position of use of the gripping unit 11 it projects axially completely or partly beyond the base body 5 at the front side 7.

Including the bottom section 65 and disregarding the longitudinal slots 69, the fastening sleeve 15 is preferably designed in a beaker-like manner.

Each pivoting region 17 in principle can be designed as a hinge with several separate constituents which are movable relative to one another. For example, each gripping arm 16 can be pivotably mounted about a bearing bolt which is fastened to the fastening sleeve 15. However, the illustrated embodiment is preferred, concerning which each pivoting region 17 is realised by way of a solid body joint 19 which results from the rear end section of the gripping arm 18 being connected to the sleeve-like fastening section 62 as a single piece and in a bending-flexible manner. The pivoting region 17 is preferably designed in the manner of a leaf spring. It results solely from the local elasticity or flexibility of the material of the gripping unit 11. In particular, in this context it is advantageous if the complete gripping unit 11 consists of a plastic material which is the case with the embodiment example. Concerning the plastic material, it is preferably the case of a polyamide plastic. A fibre reinforcement is possible.

The fastening sleeve 15 of the gripping unit 11 is open at its axial rear side 67. Here the sleeve interior 74 which is surrounded by the fastening sleeve 15 runs out axially with an assembly opening 73. On assembly of the gripping apparatus 1, the gripping unit 1 with the assembly opening in front is stuck from the front side 7 onto the base body 5 according to the stick-on movement 23.

The fastening sleeve 15 and the base body 5 are preferably matched to one another such that the fastening sleeve 13 can be stuck onto the base body 5 by way of a purely linear stick-on movement 23 for assuming the position of use.

Preferably, the gripping apparatus 1 comprises a linear guide device 75 which is effective between the base body 5 and the sleeve-like fastening section 62 of the fastening sleeve 15 and which is responsible for the stick-on movement 23 being a purely linear movement in the axis direction of the center axis 4. The linear guide device 75 furthermore effects a rotational lock between the gripping unit 11 and the base body 5 by way of it preventing a rotation of the fastening sleeve 15 which is stuck onto the base body 5, relative to the base body 5 about the center axis 4.

The linear guide device 75 comprises a guide groove 76 which is formed in the radial outer peripheral surface 14 of the base body 5, extends in the axis direction of the longitudinal axis 5a and is open to the front side 7. The guide groove 76 with regard to length is expediently restricted to the front end section 63 of the base body 5, on which the gripping unit 11 which assumes its position of use is seated.

The fastening sleeve 15 in the region of its sleeve-like fastening section 62 on the radial inner peripheral surface 64 comprises a guide rib 77 which extends in the axis direction of the longitudinal axis 11a. The guide rib 77 with regard to its width is matched to the width of the guide groove 76 so that it can engage into the guide groove 76 and slide therein amid transverse support. By way of example, the guide rib 77 extends axially on both sides of that region of the fastening sleeve 15, in which the pivoting regions 17 are situated.

For sticking onto the base body 5, the gripping unit 11 after a prior coaxial alignment with respect to the base body 5 is positioned with regard to rotation angle in a manner such that the guide rib 77 is axially flush with the guide groove 76. Given the subsequent stick-on movement 23, the guide rib 77 with its face side which faces the axial rear side 67 in front is inserted axially into the guide groove 76 of the base body 5. At the same time, the sleeve-like fastening section 62 is pushed with its sleeve opening 74 onto the front end section 63 of the base body 5.

The axial relative position which is assumed between the gripping unit 11 and the base body 5 in the position of use is defined for example in that the fastening sleeve 15 with its bottom section 65 runs onto the end-face of the base body 5 which lies at the front side 7.

A securing device 78 of the gripping apparatus 1 ensures that the gripping unit 11 is releasably fixed on the base body 5 in the stuck-on position of use. By way of the fixation, one succeeds in the gripping unit 11 being positively blocked with respect to the base body 5 in the axis direction of the center axis 4 in a manner such that it cannot be inadvertently pulled down again from the base body 5. In particular, it is axially immovably secured on the base body 5. On the other hand, the securing device 78 is designed such that at all times such a de-securing to the extent that the gripping unit 11 can be axially withdrawn from the base body 5 into the standby position in the counter-direction of the stick-on movement 23 is possible.

The components of the securing device 78 which cooperate with one another are arranged on the one hand on the base body 5 and on the part of the fastening sleeve 15 are preferably arranged on the sleeve-like fastening section 62.

The securing device 78 is preferably conceived as a locking device 79. This is the case with the illustrated embodiment example.

The locking device 79 has a first locking structure 82 which is immovably arranged on the base body and a second locking structure 83 which is designed in a movable manner, is complementary to the first locking structure 82 and is arranged on the sleeve-like fastening section 62. On account of the movability of the second locking structure 83 which is indicated in the FIGS. 2 and 9 at 84 by a double arrow, the second locking structure 83 can be moved between a locking position and an unlocking position.

By way of example, the first locking structure 82 is designed as a locking deepening 82a which is incorporated into the radial outer peripheral surface 14 of the base body 5. The movable second locking structure 83 which belongs to the fastening sleeve 15 comprises a bar element 84 which is movable according to the double arrow 84, with a locking projection 83a which projects radially inwards in the region of the radial inner periphery 64 of the sleeve-like fastening section 62. The locking deepening 82a and the locking projection 83a are preferably designed in a complementary manner such that they can positively engage into one another and by way of this block the movability of the gripping unit 11 relative to the base body 5 in the axis direction of the center axis 4.

Concerning the illustrated embodiment example, the bar element 85 is arranged in a wall recess 86 of the sleeve-like fastening section 62 and is connected to the fastening section 62 as one piece and in a pivotably moveable manner via a spring-elastic connection section 87. The movability 84 of the bar element 85 which results from this is a pivoting movability. The wall recess 86 passes through the wall of the sleeve-like fastening section 62.

The two locking structures 82, 83 are arranged such that they can engage into one another in the position of use of the gripping unit 11. By way of the connection section 87, the bar element 85 is held in a home position which corresponds to the already mentioned locking position, in which the locking projection 83a positively immerses into the locking deepening 82a with a locking effect.

On account of a manual introduction of force, if necessary amid the use of a suitable lever tool such as for example a screw driver, the bar element 85 when necessary can be pivoted away from the base body 5 into the unlocking position whilst carrying out the pivoting movement 84, in which unlocking position the locking projection 83a is disengaged from the locking deepening 82a. In this state, the locking effect is lifted and the gripping unit 11 can be axially withdrawn from the base body 5 in an uninhibited manner.

The bar element 85 is preferably suspended in a spring-elastic manner via the connection section 87, so that a spring-elastic restoring force must be overcome for the unlocking movement 84. If the unlocked bar element 85 is subsequently let go of, then on account of the spring-elastic suspension its automatically returns into the locking position. Inasmuch as this is concerned, in the illustrated embodiment example the locking device 79 is simultaneously designed as a snap connection device 79a which has the effect of the two locking structures 82, 83 automatically latching with one another on sticking the gripping unit 11 onto the base body 5 when the stuck-on position of use is achieved. During the sliding-on, the bar element 85 by way of contact with the radially outer peripheral surface 14 is moved into the unlocking position in which it remains until it gets into the region of the locking deepening 82a given the stick-on movement 23. Given the stick-on movement 23, the bar elements 85 slides on the radially outer peripheral surface 14.

The first locking structure 82 is preferably placed on the base body 5 such that it lies in the longitudinal course of the guide groove 76 of the linear guide device 75. By way of example, the guide groove 76 is axially subdivided into two groove length sections 86a, 86b by the first locking structure 82 which is designed as a locking deepening 82a, said groove longitudinal sections running out from opposite axial sides into the locking deepening 82a according to FIG. 3.

Likewise by way of example, the locking element 85 is integrated into the longitudinal course of the guide rib 77 such that it divides the guide rib 77 into two rib length sections 77a, 77b which are axially distanced to one another.

The releasable fixation of the gripping unit 11 on the base body 5 permits all gripping arms 18 to be exchanged for other gripping arms with a simple, unitary handling measure. The exchange measure each encompasses the complete gripping unit 11. Preferably, several gripping units 11 are kept ready in a disassembled stand-by position and in their design correspond to their fastening sleeve 15 but differ from one another in the design of the gripping arms 18. Depending on the application purpose, one of the several gripping units 11 which are held ready can then be selectively assembled on the base body 5. The simple releasably of the gripping unit 11 also permits a rapid exchange of the complete gripping unit 11 in the case of damage.

For creating the gripping arm pivoting movement 22, the gripping apparatus is provided with a suitable actuation device 26.

The actuation device 76 in principle can be based on a mechanical functioning principle and be designed to introduce actuation forces into the gripping arms 18 by way of mechanical contact, in order to create the gripping arm pivoting movement 22.

Preferably and according to the illustrated embodiment example, the actuation device 26 is designed as a permanent-magnetic actuation device 26a. Here, the forces which create the gripping arm pivoting movements 22 are introduced into the gripping arms 18 in a contact-free manner and thus without wearing, by way of magnetic force.

The permanent-magnetic actuation device 26a preferably has an outer permanent magnet arrangement 27 which is arranged on the gripping arms 18, and an inner permanent magnet arrangement 34 which is in magnetic interaction with this outer permanent magnet arrangement 27 and is assigned to the base body 5.

The outer permanent magnetic arrangement 27 is composed of several individual outer permanent magnet units 28 whose number corresponds to that of the gripping arms 18, wherein an individual outer permanent magnet unit 28 is fixedly arranged on each gripping arm 18.

With respect to the axis direction of the center axis 4, the external permanent magnet units 28 of all gripping arms 18 are preferably arranged at the same axial height. They commonly lie in a drive plane which is at right angles to the center axis 4.

The inner permanent magnet arrangement 34 is a constituent of an actuation unit 15 which is carried by the base body 5 and which can be rotated relative to the base body 5 whilst carrying out a rotational working movement 36 which is rendered recognisable by a double arrow, and also relative to the gripping arms 18, and specifically about a rotation axis 39 which coincides with the center axis 4. The actuation unit 35 is received in a housing chamber 38 of a housing 37 at the height of the aforementioned drive plane, wherein the housing 37 forms a constituent of the base body 5 or according to the illustrated embodiment example forms the base body 5. The housing 37 by way of example has a housing side wall 42 which extends around the center axis 4, by way of example is designed hollow-cylindrically and whose radial outer surface forms the outer peripheral surface 14, on which the gripping unit 11 which is positioned in the position of use is seated.

The inner permanent magnet arrangement 34 has a plurality of inner permanent magnet units 47 which are arranged at a radial distance to the rotation axis 39 and which are furthermore distributed about this rotation axis 39 at a mutual angular distance. Preferably, all inner permanent magnet units 47 lie on a circle, whose center lies on the rotation axis 39. All inner permanent magnet units 47 expediently lie with the outer permanent magnet units 28 in one and the same drive plane.

By way of the rotational working movement 36, the actuation unit 35 including the inner permanent magnet units 47 can be positioned at different rotational working positions. Expressed differently, the actuation unit 35 can be brought into different rotational angle positions by way of the rotational working movement 36. With this working movement 36, the relative position of the inner permanent magnet units 47 which is assumed with respect to the outer permanent magnet units 28 changes, by which means the magnetic forces which act between the inner permanent magnet units 47 and the outer permanent magnet units 28 can be changed. Herein, the outer permanent magnet units 28 and consequently the gripping arms 18 which are equipped with these outer permanent magnets 28 are either attracted or repelled by the inner permanent magnet units 47. The inwards pivoting movement 22a results from the attracting magnetic effect and the outwards pivoting movement 22b from the repelling magnetic effect.

The actuation unit 35 preferably comprises a disc-like carrier body 44 which carries the inner permanent magnet units 37 and via which the actuation unit 35 is rotatably mounted with respect to the base body 5. The inner permanent magnet units 47 are fixed to the carrier body 44 at a radial distance to the rotation axis 39. For this, the inner permanent magnet units 47 are received and held for example in receiving pockets 46 on the radial outer periphery of the carrier body 44. Concerning the illustrated embodiment example, the outer permanent magnet units 28 are arranged with polarisation directions which are opposite to one another in an alternating manner in the rotation direction 36 of the actuation unit 35, thus about the rotation axis 39. The polarisation directions are each aligned radially with respect to the rotation axis 39. Hence north poles “N” and south poles “S” alternate in the rotation direction 36 of the actuation unit 35 on the inner sides of the outer permanent magnet units 228 which radially face the rotation axis 39. This can be easily seen in FIG. 5.

The inner permanent magnet units 47, whose number preferably corresponds to the number of outer permanent magnet units 28, are likewise arranged with polarisation directions which are opposite to one another in a manner alternating in the rotation direction 36, wherein the inner permanent magnet units 47 are positioned radially. In FIG. 5, the north poles are indicated by “N” and the south poles by “S”.

On account of the outlined arrangement, there is the possibility of positioning the actuation unit 35 in at least two rotational working positions by way of the rotational working movement 36, in which positions either equal poles or unequal poles of the inner and outer permanent magnet units 47, 28 lie radially opposite one another. A working position, in which unequal magnet poles lie opposite one another is shown in FIG. 5, so that the gripping arms 18 are attracted for assuming the closure position. If equal poles lie opposite one another, which by way of example is the case after a rotation of the actuation unit 35 by 90 degrees, the oppositely lying inner and outer permanent magnet units 47, 28 repel, so that the gripping arms 18 are moved outwards into the open position which is indicated by a dot-dashed line in FIG. 5.

It is to be understood that for realising the magnetic interaction, other distributions and polarisation directions of the inner and/or outer permanent magnet units 47, 28 can also be provided.

Concerning an alternative embodiment example which is not illustrated, the working movement of the actuation unit is a linear movement in the axis direction of the center axis 4. Here, the actuating unit is linearly displaced in a manner comparable to the piston of a fluid-actuated working cylinder, in order to actuate the gripping arms 18. The actuation can be effected by way of fluid force or electrically.

In order for the inner and outer permanent magnet units 47, 28 to magnetically interact without any problem, it is expedient if the housing side wall 42 of the housing 37 consists of a non-magnetisable material at least one the region of the inner and outer permanent magnet units 47, 28.

For generating the working movement 36 of the actuation unit 35, the gripping apparatus 1 is expediently provided with a drive unit 52. This drive unit 52 can be for example of a construction type which can be actuated by way of fluid force, but is preferably of an electrically actuatable construction type in accordance with the embodiment example.

The drive unit 52 is expediently received in the housing chamber 38 of the housing 37. In particular, it is arranged there in the coaxial extension of the actuation unit 35, in particular at the side of the actuation unit 35 which faces the rear side 6.

The drive unit 52 has a drive housing 53 via which it is fastened to the housing 37 of the base body 5. A driven shaft 54 which projects out of the drive housing 53 is coupled in drive to the carrier body 44 of the actuation unit 35 for generating the rotational working movement 36.

Concerning the illustrated embodiment example, the drive unit 52 is designed as an electric motor. Preferably, the drive unit 52 is an electrical servo-motor, with which the actuation unit 35 can be steplessly rotated and positioned with regard to the rotation angle in accordance with the requirements. Electrical control commands which are necessary for this are provided for example by an electric control device 56 which is preferably likewise a constituent of the gripping apparatus 1 and is electrically connected to the drive unit 52. For the electric connection, the base body 5 is expediently provided with one or more electromechanical interfaces 57.

Preferably the drive unit 52 permits the generation of a bi-directional rotational working movement 36 of the actuation unit 35. This permits an opening and closing of the gripping arms 18 by way of the selective rotation in the clockwise direction or anticlockwise direction of the actuation unit 35.

Expediently, the gripping apparatus 1 is provided with a sensor device 88 which is designed for the detection of at least one operating state of the gripping apparatus 1. In particular, the sensor device 88 is in the position of detecting at least one and in particular each of the pivoting positions of the gripping arms 18 which can be set by the gripping arm pivoting movements 22.

By way of example, the sensor device 88 comprises several Hall sensors which are accommodated in the inside of the housing 37 in a manner such that they lie in the region of influence of the inner permanent magnet arrangement 34 as well as the outer permanent magnet arrangement 37. By way of this, the sensor device 88 is in the position of detecting the pivoting positions of the gripping arms 18 as well as the rotation position of the actuation unit 35 and transferring it to the control device 56. This positional information can be used in order to control the gripping arms 18 for carrying out the gripping arm pivoting movement 22. In particular, there is the possibility of detecting the momentary degree of opening of the gripping arms 18. The rotational angle of the actuation unit 35 can also be determined and controlled by the position detection of the inner permanent magnet arrangement 34.

Expediently, the gripping apparatus 1 is provided with a light display device 92 by way of which the at least one operating state of the gripping apparatus 1 can be visualised. In particular, on account of the light display device 92 there is the possibility of indicating gripping arms positions of the gripping arms 18 by way of optical signals. For example, the open position and the closure position can be visualised by different light colours. In particular, the light display device 92 is activated on the basis of sensor signals which are provided by the sensor device 88, wherein a direct control is possible as well as an indirect control amid the intermediate arrangement of the electronic control device 56.

The light display device 92 is expediently accommodated in the inside of the housing chamber 38 of the housing 37 in a manner shielded from external influences. The sensor device 88, the drive unit 52 and the actuation unit 35 are expediently also located there. A circuit board 93 with electronic components and onto which the electromagnetic interface 57 is connected can also be located in the housing chamber 38. The drive unit 52, the sensor device 88 and the light display device 92 are preferably connected onto the circuit board via electrical leads, from which circuit board an electrical connection to the electronic control device 56 is effected.

The housing chamber 38 and the components which are located therein are expediently encapsulated from the environment in a hermetically sealed manner by way of the housing 37.

Several wall openings 94 which are arranged in a manner distributed about the center axis 4 are formed in the housing side wall 42 in the region of the light display device 92. The light signals which are emitted by the light display device 92 can penetrate through these wall openings 94 which are expediently closed in a light-transparent manner, to the outside to an observer. Preferably, the light display device 92 comprises several LEDs which are for generating light and which are each placed on the housing chamber 38 in the region of one of the wall openings 94. By way of example, four wall openings 94 each with an assigned LED of the light display device 92 are present.

The wall openings 94 are preferably located in that length section of the housing side wall 42 which is covered by the fastening sleeve 15 of the gripping unit 11 assuming the position of use. By way of example, the wall openings 94 are formed in the rear sleeve end section 70 which connects onto the front sleeve end section 68 at the rear side.

Despite the assembled gripping unit 11, the light signals of the light display device 92 can be easily recognised from the outside since a viewing window 95 through which the light signals can pass to the outside passes through the sleeve-like fastening section 62 in the region of each one of the wall openings 94 of the housing side wall 42. The viewing windows 95 are formed by openings of the wall of the fastening sleeve 15 and can be open or closed in a transparent manner. The peripheral distribution with respect to the fastening sleeve 15 corresponds to that of the wall openings 94 so that one of the viewing windows 95 is flush with each wall opening 94. By way of example the viewing window 95 is located in the rear sleeve end section 70. Preferably, the second locking structure 83 is also formed in this rear sleeve end section 70.

The number of wall opening 94 and viewing windows 95 can different from the example. For example, only a single wall opening 94 and/or only a single viewing window 95 can be present.

The gripping unit 11 can be manufactured in an inexpensive manner. For example, an injection moulded manufacture is possible. This is favoured due to the fact that no thread is formed on the radial inner peripheral surface 64 of the sleeve-like fastening section 62 and in particular on the complete fastening sleeve 15. The radial inner peripheral surface 64 is preferably designed in a smooth-surfaced manner. The same applies to the section of the radial outer peripheral surface 14 of the base body 5, said section being covered by the fastening sleeve 15 in the position of use.

1. A gripping apparatus, comprising a base body and several gripping arms which are arranged on the base body in a manner distributed about a center axis, wherein each gripping arm is pivotable relative to the base body about a pivoting region whilst carrying out a gripping arm pivoting movement and wherein all gripping arms, by way of an actuation device of the gripping apparatus, can be driven synchronously in a selective manner into an inwards pivoting movement which is orientated inwards in the direction of the center axis or into an outwards pivoting movement which is oriented outwards away from the center axis and wherein the gripping arms are integrated into a gripping unit, said gripping unit being separate with respect to the base body, comprising a fastening sleeve which carries all gripping arms, being stuck with a sleeve-like fastening section of the fastening sleeve onto the base body in the axis direction of the center axis and in a position of use which is assumed by way of this being releasably fixed on the base body by way of a securing device.

2. The gripping apparatus according to claim 1, wherein the fastening sleeve for assuming the position of use can be stuck or is stuck onto the base body by way of a purely linear stick-on movement.

3. The gripping apparatus according to claim 1, wherein the securing device is designed such that it is effective between the base body and the sleeve-like fastening section of the fastening sleeve.

4. The gripping apparatus according to claim 1, wherein the securing device is formed by way of at least one locking device which has a first locking structure which is arranged on the base body and a second locking structure which is arranged on the sleeve-like fastening section of the fastening sleeve and is complementary to the first locking structure, wherein one of the two locking structures is immovable and the other locking structure is movable for carrying out a locking procedure and an unlocking procedure.

5. The gripping apparatus according to claim 4, wherein the first locking structure is arranged on the base body in an immovable manner and the second locking structure is movably arranged on the sleeve-like fastening section of the fastening sleeve.

6. The gripping apparatus according to claim 4 wherein the locking device is designed as a snap-connection device, wherein the movable first or second locking structure can be deflected in a spring-elastic manner for unlocking.

7. The gripping apparatus according to claim 1, further comprising at least one linear guide device which is effective between the base body and the sleeve-like fastening section of the fastening sleeve and by way of which the fastening sleeve is guided in a linearly displaceable manner on axially sticking onto the base body and on axially withdrawing from the base body and by way of which the fastening sleeve is supported in a non-rotatable manner with respect to the base body in the position of use of the gripping unit in which it is stuck onto the base body.

8. The gripping apparatus according to claim 7, wherein the linear guide device comprises a guide groove, said guide groove being formed in an outer peripheral surface of the base body which faces radially outwards with respect to the center axis and extending in the axis direction of the center axis, and a guide rib which engages into the guide groove in a slidingly displaceable manner and which is formed on a radial inner peripheral surface of the sleeve-like fastening section of the fastening sleeve.

9. The gripping apparatus according to claim 8 wherein the securing device is formed by way of at least one locking device which has a first locking structure which is arranged on the base body and a second locking structure which is arranged on the sleeve-like fastening section of the fastening sleeve and is complementary to the first locking structure, wherein one the two locking structures is immovable and the other locking structure is movable for carrying out a locking procedure and an unlocking procedure, and wherein the first locking structure is arranged in the longitudinal course of the guide groove of the linear guide device and the second locking structure is arranged in the longitudinal course of the guide rib of the linear guide device.

10. The gripping apparatus according to claim 1, wherein the inner peripheral surface of the sleeve-like fastening section of the fastening sleeve and the section of the outer peripheral surface of the base body, said section being encompassed by the sleeve-like fastening section of the fastening sleeve in the position of use of the gripping unit, are designed in a circularly cylindrical manner and complementarily to one another.

11. The gripping apparatus according to claim 1, wherein at least one viewing window passes through the sleeve-like fastening section of the fastening sleeve, through which viewing window a light display device is visible from the outside, said light display device being accommodated in the base body, visualising at least one operating state of the gripping apparatus and being electrically actuatable.

12. The gripping apparatus according to claim 1, wherein the fastening sleeve at an axial front side comprises a closed bottom section which is arranged axially in front of the base body at a front side in the position of use of the gripping unit.

13. The gripping apparatus according to claim 1, wherein the gripping arms each comprise a rear end section, with which they are fixed to the sleeve-like fastening section of the fastening sleeve in a pivotably movable manner whilst defining their respective pivoting region, wherein each gripping arm with an axially opposite front end section which forms the gripping section projects axially beyond the fastening sleeve.

14. The gripping apparatus according to claim 1, wherein each gripping arm at its rear end section is connected to the sleeve-like fastening section of the fastening sleeve as one piece and in a bending-flexible manner amid the formation of a solid-body joint.

15. The gripping apparatus according to claim 1, wherein the fastening sleeve comprises a front sleeve end section which is designed in a sleeve-like manner and through whose wall several longitudinal slots pass, said slots being distributed around the center axis wherein in each longitudinal slot one of the gripping arms extends.

16. The gripping apparatus according to claim 1, wherein the actuation device is designed as a permanent-magnetic actuation device which comprises an external permanent magnet arrangement with outer permanent magnet units which are arranged on the gripping arms and an inner permanent magnet arrangement which interacts with this and which is surrounded by the gripping arms, wherein the inner permanent magnet arrangement is a constituent of a movable actuation unit of the permanent-magnetic actuation device, said actuation unit being able to be positioned in different working positions relative to the base body as well as relative to the gripping arms by way of carrying out a working movement, so that the outer permanent magnet units are attracted or repelled by magnet forces for creating the gripping arm pivoting movements.

17. The gripping apparatus according to claim 16, wherein the base body comprises a housing which defines a housing chamber, in which the actuation unit is received, wherein the housing chamber is peripherally delimited by a housing side wall which is non-magnetisable at least in the region of the actuation unit and around which the actuation sleeve with the gripping arms which are arranged thereon is placed.

18. The gripping apparatus according to claim 1, further comprising a sensor device which is designed for detecting at least one operating state of the gripping apparatus.

19. The gripping apparatus according to claim 18, wherein the sensor device is capable of detecting at least one pivoting position of each gripping arm, said pivoting position being adjustable by way of the gripping arm pivoting movements.

20. The gripping apparatus according to claim 14, wherein the complete gripping unit consists of a plastic material.
